(19) United States
(12) Patent Application Publication
(10) Pub. No.: US 2025/0271685 A1
(43) Pub. Date: Aug. 28, 2025

(54) ADAPTABLE EYEWEAR FRAME AND METHOD OF USING THE SAME

(71) Applicant: Keyaunna Raeshae Morgan, Memphis, TN (US)

(72) Inventor: Keyaunna Raeshae Morgan, Memphis, TN (US)

(21) Appl. No.: 18/587,360

(22) Filed: Feb. 26, 2024

(51) Int. Cl. G02C 5/00; G02C 3/00

(52) U.S. Cl. CPC G02C 5/008; G02C 3/003

(57) ABSTRACT

Various embodiments of the present invention are directed to an adaptable eyewear frame and a method of using the same. In some embodiments, the eyewear frame includes a first frame member defining at least one lens portion formed from flexible material. The at least one lens portion may define at least one opening configured to receive any lens of a plurality of lenses. The adaptable eyewear frame may include at least one second frame member coupled to the first frame member. The at least one second frame member may be configured for removably securing the first frame member to a user. In some embodiments, a method of using the adaptable eyewear frame includes providing positioning a lens within the at least one receiving portion of the adaptable eyewear frame and positioning the first frame member on a user's face.

### TECHNOLOGICAL FIELD

The present disclosure relates to eyewear frame and in certain embodiments, to an adaptable eyewear frame configured for use with any lens of a plurality of lenses.

### BACKGROUND

Eyewears are essential for various applications, including protecting a user's eyes when worn over the user's face, aiding vision correction of a user wearing the eyewear, and/or the like. Examples of an eyewear include prescription glasses, sunglasses, safety goggles, ski goggles, and/or the like. An eyewear may include various components, (e.g., frame, lenses, and/or the like). These components may break or otherwise malfunction over time, which in turn prompts a need to replace these components or the entire eyewear.

Conventional methods and/or devices related to replacing an eyewear are time-consuming, expensive, and provide limited options. Thus, a need exists for an adaptable eyewear frame that is durable and compatible with any of a variety of lens types, lens shapes, lens weights, and/or other lens characteristics to at least provide flexibility, reduce replacement cost, and reduce wasted time.

### BRIEF SUMMARY

Various embodiments of the present invention are directed to an adaptable eyewear frame. According to one aspect of the present disclosure an adaptable eyewear frame is provided. In various embodiments, the adaptable eyewear frame comprises: an adaptable eyewear frame comprising a first frame member defining at least one lens portion formed from flexible material, the at least one lens portion defining at least one opening configured to receive any lens of a plurality of lenses; and at least one second frame member coupled to the first frame member, the at least one second frame member configured for removably securing the first frame member to a user.

In various embodiments, the at least one lens portion is configured to conform to any of the plurality of lenses positioned within the at least one lens portion to secure the lens within the first frame member.

In various embodiments, the at least one lens portion takes a shape of a lens of the plurality of lenses that is positioned within the at least one lens portion.

In various embodiments, the at least one lens portion defines a recess along an interior perimeter of the at least one lens portion for releasably securing a lens of the plurality of lenses within the at least one lens portion.

In various embodiments, the at least one lens portion has an interior perimeter that is the same or less than a perimeter of each of the plurality of lenses prior to positioning a lens of the plurality of lenses therein.

In various embodiments, the at least one lens portion is configured to expand when a lens of the plurality of lenses is placed within the at least one lens portion.

In various embodiments, the at least one lens portion comprises a first lens portion and a second lens portion that are spaced apart relative to one another.

In various embodiments, the at least one lens portion comprises a single lens portion that extends a width of the first frame member.

In various embodiments, the plurality of lenses comprises a lens having a substantially round shape.

In various embodiments, the plurality of lenses comprises a lens having an irregular shape.

In various embodiments, the at least one second frame member comprises a first arm and a second arm.

In various embodiments, the at least one second frame member comprises a headband.

According to another aspect of the present disclosure an eyewear is provided. In various embodiments, the eyewear comprises: an eyewear frame comprising: a first frame member defining at least one lens portion formed from flexible material, the at least one lens portion defining at least one opening configured to receive any lens of a plurality of lenses; and at least one second frame member coupled to the first frame member, the at least one second frame member configured for removably securing the first frame member to a user.

In various embodiments, the eyewear further comprises at least one lens secured within the at least one lens portion.

According to yet another aspect of the present disclosure a method for using an eyewear frame provided. In various embodiments, the method comprises: providing an eyewear frame comprising: a first frame member defining at least one lens portion formed from flexible material, the at least one lens portion defining at least one opening configured to receive any lens of a plurality of lenses; and at least one second frame member coupled to the first frame member, the at least one second frame member configured for removably securing the first frame member to a user; and positioning a lens of the plurality of lenses within the at least one lens portion.

In various embodiments, the method further comprises positioning the first frame member on a user's face; and securing the first frame member on the user's face using the at least one second frame member.

In various embodiments, the at least one lens portion defines a recess along an interior perimeter of the at least one lens portion, and positioning the lens within the at least one lens portion comprises positioning the lens within the recess.

In various embodiments, positioning the lens within the at least one lens portion comprises securing the lens within the at least one lens portion utilizing a friction-type fit.

In various embodiments, the at least one lens portion conforms to a shape of the lens.

In various embodiments, the method further comprises removing the lens; and positioning a different lens within the at least one lens portion.

### BRIEF DESCRIPTION OF THE DRAWINGS

Reference will now be made to the accompanying drawings which are not necessarily drawn to scale, and wherein:

FIG. 1 shows a front view of an adaptable eyewear frame in accordance with at least one embodiment described herein.

FIG. 2a shows a perspective view of an adaptable eyewear frame with lenses inserted therein in accordance with at least one embodiment described herein.

FIG. 2b shows a front view of an adaptable eyewear frame with lenses inserted therein in accordance with at least one embodiment described herein.

FIG. 3 shows an adaptable eyewear frame and example lenses in accordance with at least one embodiment described herein.

FIG. 4 shows an adaptable eyewear frame in a folded orientation in accordance with at least one embodiment described herein.

FIG. 5 is a flow chart illustrating a method of use of the adaptable eyewear frame in accordance with at least one embodiment described herein.

### DETAILED DESCRIPTION

Various embodiments of the present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout. The term “or” is used herein in both the alternative and conjunctive sense, unless otherwise indicated. The terms “illustrative,” “example,” and “exemplary” are used to be examples with no indication of quality level. The term “approximately” refers to within engineering and/or manufacturing limits. Like numbers refer to like elements throughout.

Various embodiments of the present invention are directed to an adaptable eyewear frame. According to various embodiments, the adaptable eyewear frame may be configured for being worn on the face of a user and may include a first frame member coupled to a pair of arms, headband, and/or the like for securing the eyewear frame on the face of the user. As described in greater detail herein, the first frame member may define at least one lens portion configured for receiving any lens of a plurality of lenses having different shapes, dimensions, weights, and/or the like. For example, the first frame member may include a pair of lens portions, where at least one of the lens portions is configured for receiving any lens of a plurality of lenses (e.g., lenses of various shapes, dimensions, weights, and/or the like). As another example, the first frame member may include a single lens portion, where the single lens portion is configured for receiving any lens of a plurality of lenses (e.g., lenses of various shapes, dimensions, weights, and/or the like).

At least a portion of the lens portion(s) may be made from flexible and/or elastic material to enable the lens portions(s) to conform to any of the plurality of lenses such that any lens of a plurality of lenses may be secured within the lens portions(s). In this regard, the adaptable eyewear frame may be utilized as a replacement eyewear frame configured for receiving and removably securing any of a variety of lenses.

### I. Adaptable Eyewear Frame

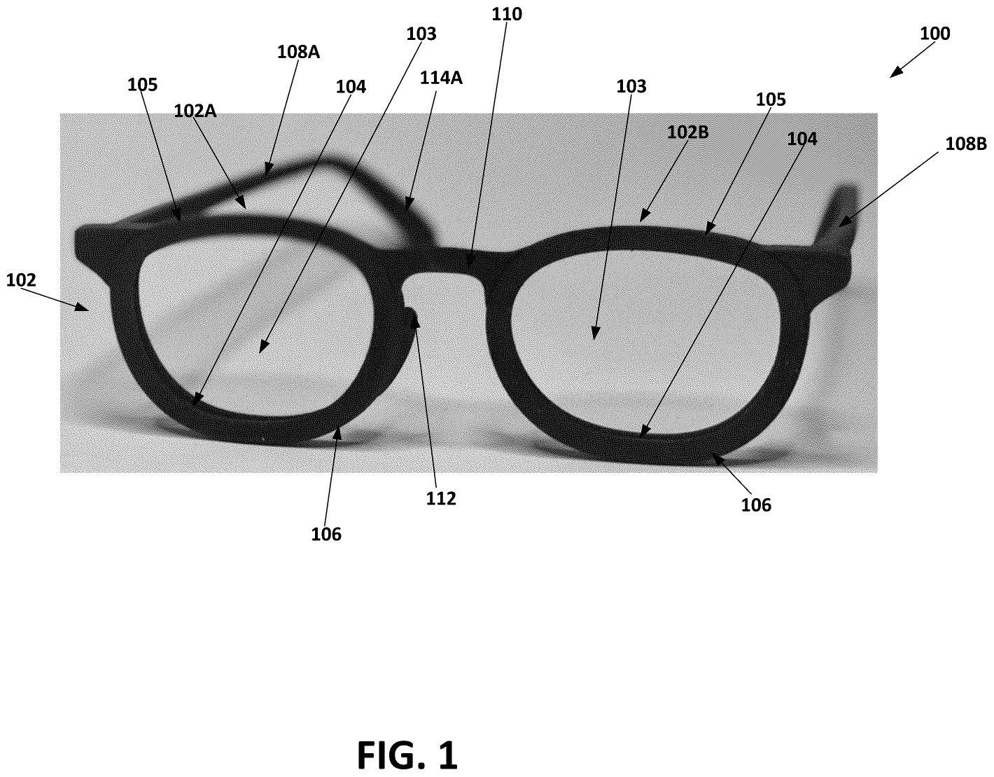

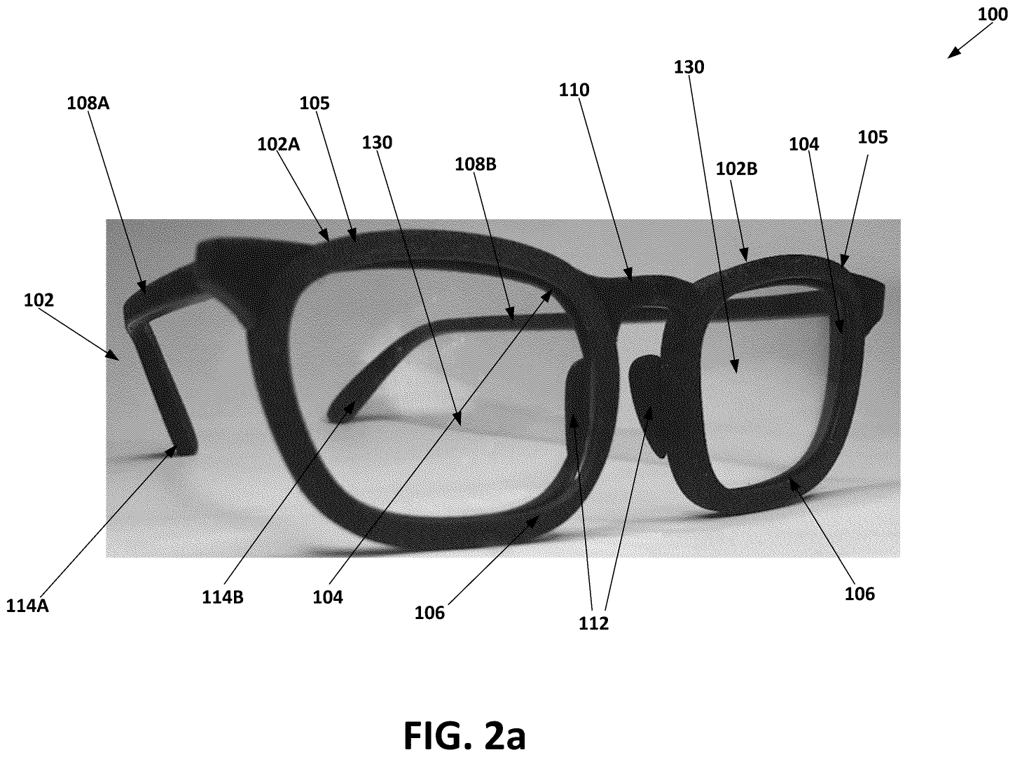

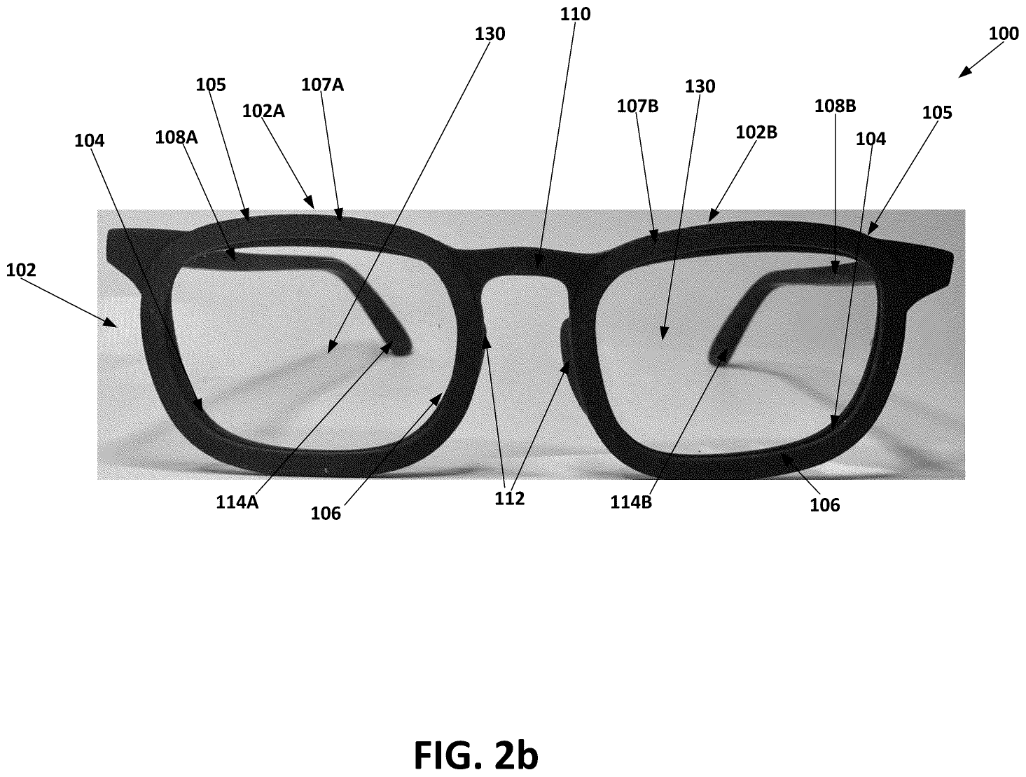

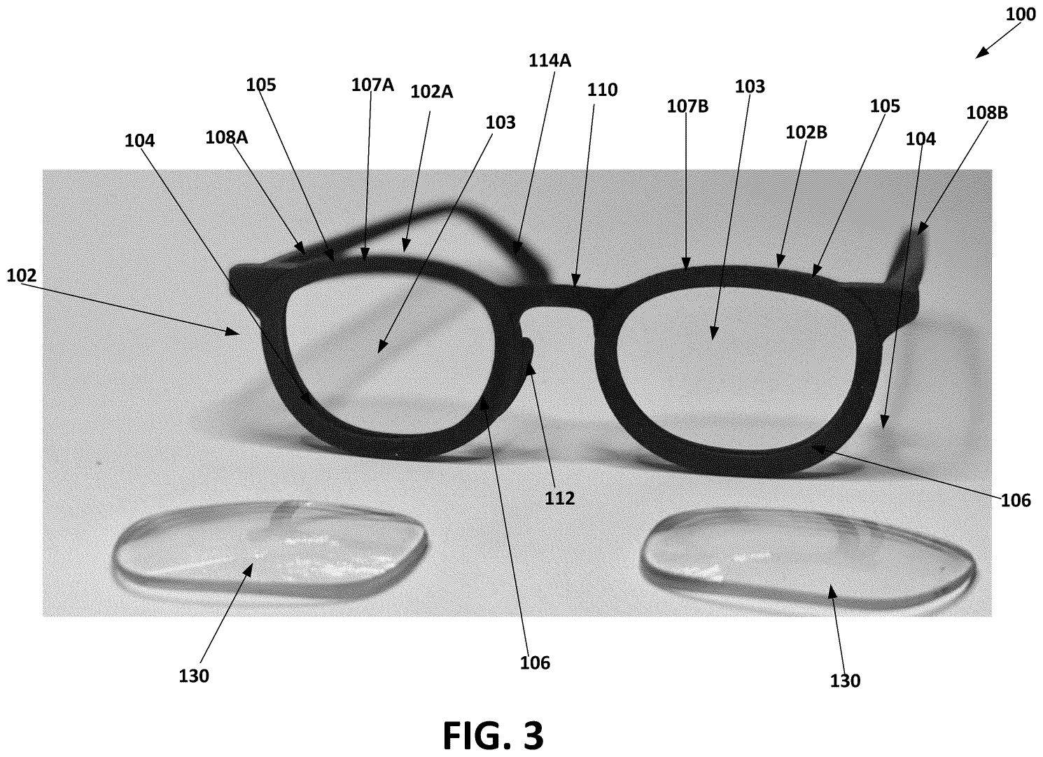

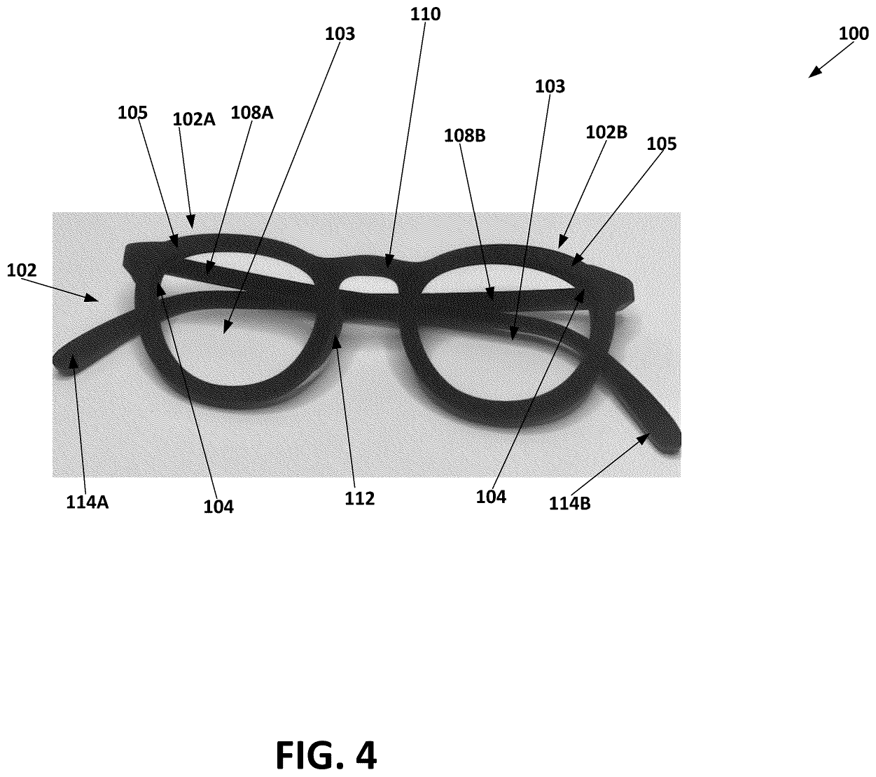

FIG. 1 shows a front view of an example adaptable eyewear frame 100 in accordance with some embodiments of the present disclosure. FIG. 2a shows a perspective view of an adaptable eyewear frame with lenses inserted therein in accordance with at least one embodiment described herein. FIG. 2b shows a front view of an adaptable eyewear frame with lenses inserted therein in accordance with at least one embodiment described herein. FIG. 3 shows an adaptable eyewear frame and example lenses in accordance with at least one embodiment described herein. Specifically, FIG. 3 shows an example adaptable eyewear frame depicted in FIGS. 2a and 2b after inserting examples lenses therein. In this regard, FIGS. 2a and 2b depict an eyewear comprising an adaptable eyewear frame and lenses inserted therein in accordance with at least one embodiment describe herein. FIG. 4 shows an adaptable eyewear frame in a folded orientation in accordance with at least one embodiment described herein.

With reference to FIGS. 1-4, the adaptable eyewear frame 100 comprises a first frame member 102. In various embodiments, the first frame member defines at least one lens portion configured to receive at least one lens therein. In some embodiments, and as illustrated in FIGS. 1-4, the at least one lens portion may comprise a first lens portion 102A and a second lens portion 102B. For example, the adaptable eyewear frame 100, in some embodiments, may be configured for use as prescription eyeglass, sunglass, safety glasses, ski glasses and/or the like having two lens portions that are each configured for receiving a lens.

In some embodiments, the at least one lens portion may comprise a single lens portion (not shown). For example, the first frame member 102 may comprise a single lens portion that encompasses or otherwise extends a width of the first frame member 102. For example, the adaptable eyewear frame 100, in some embodiments, may be configured for use as ski goggle, safety glasses, and/or the like having a single lens portion configured for receiving a lens.

With reference to FIGS. 1-4, the first lens portion 102A and the second lens portion 102B may be spaced apart relative to one another. In some embodiments, the first frame member 102 may include a bridge 110 between the first lens portion 102A and the second lens portion 102B. The bridge 110 may connect the first lens portion 102A and the second lens portion 102B together and may be configured to be positioned on a nose of a user.

In some embodiments, each of the first lens portion 102A and the second lens portion 102B may include a nose pad 112 positioned on the first lens portion 102A and the second lens portion 102B in a manner that when the first frame member 102 is positioned on a user's face, each of the nose pads 112 rests on the user's nose. It should be understood that in some embodiments, the first frame member 102 may not include nose pads.

The at least one lens portion may define at least one opening 103 configured to receive any lens of a plurality of lenses 130. For example, as shown in FIGS. 1-2, the first lens portion 102A may comprise a first rim portion 107A and the second lens portion 102B may comprise a second rim portion 107B. The first rim portion 107A and the second rim portion 107B may each define an opening 103. For example, the first rim portion 107A of the first lens portion 102A and the second rim portion 107B of the second lens portion 102B may each comprise an exterior perimeter 105 and an interior perimeter 106 that defines an opening 103 configured for receiving any lens of a plurality of lenses 130.

In various embodiments, the exterior perimeter 105 of the at least one lens portion may be substantially circular, substantially spherical, substantially square, substantially rectangular, substantially polygonal, and/or have a variety of other shapes (including irregular shapes). In various embodiments, the interior perimeter 106 of the at least one lens portion may be substantially circular, substantially spherical, substantially square, substantially rectangular, substantially polygonal, and/or have a variety of other shapes (including irregular shapes). In various embodiments, the shape of the interior perimeter 106 of the at least one lens may be approximately the same as the shape of the exterior perimeter 105 of the at least one lens. In some embodiments, the shape of the interior perimeter 106 of the at least one lens portion may be different from the shape of the exterior perimeter 105 of the at least one lens portion.

In various embodiments, the at least one receiving portion (e.g., at least a portion of the first lens portion 102A and/or the second lens portion 102B) defines a recess 104 along an interior perimeter 106 of the at least one lens portion. For example, each of the first rim portion 107A of the first lens portion 102A and the second rim portion 107B of the second lens portion 102B may define a recess 104 (e.g., a channel and/or the like) along respective interior perimeter 106 for releasably securing any lens of a plurality of lenses 130 within the first lens portion 102A and the second lens portion 102B. In this regard, the recess 104 may be configured to facilitate releasably securing of any lens of a plurality of lenses 130 within the at least one lens portion.

In some embodiments, the at least one lens portion has an interior perimeter 106 that is the same or less than a perimeter of each of the plurality of lenses 130 prior to positioning any of the plurality of lenses 130 within the at least one lens. A portion of the at least one lens portion may be configured to expand when a lens is placed within the at least one lens portion to adequately secure a lens therein. For example, the interior perimeter of the first lens portion 102A and the second lens portion 102B may be made of material that is elastic. For example, at least a portion of the first lens portion 102A and at least a portion of the second lens portion 102B may be made of material that enables securing of any of a variety of lenses 130 within the first lens portion 102A and the second lens portion 102B. In some embodiments, the at least one receiving portion may be configured for securing a lens therein utilizing a friction-type fit.

The at least one lens portion may be configured to conform to a lens that is positioned within the at least one lens portion. For example, the first lens portion 102A and/or the second lens portion 102B may be configured such that any of a first lens having a substantially round shape, a second lens having a substantially oval shape, a third lens having a substantially rectangular shape, a fourth lens having a substantially square shape, or a fifth lens having a different shape may be securely positioned within the first lens portion 102A and/or the second lens portion 102B. As another example, the first lens portion 102A and/or the second lens portion 102B may be configured such that any lens of a plurality of lenses 130 having different weights and/or dimensions may be securely positioned within the first lens portion 102A and/or the second lens portion 102B.

In some embodiments, the at least one receiving portion (e.g., at least a portion of the first lens portion 102A and/or the second lens portion 102B) is configured to take the shape of the lens that is positioned within the at least one lens portion. In some embodiments, the interior perimeter 106 of the at least one receiving portion is configured to take the shape of the lens that is positioned within the at least one lens portion. For example, the interior perimeter 106 of the first lens portion 102A may take a substantially round shape when a substantially round lens is positioned within the first lens portion 102A. As another example, the interior perimeter 106 of the first lens portion 102A may take a substantially oval shape when a substantially oval lens is positioned within the first lens portion 102A. As yet another example, the interior perimeter 106 of the second lens portion 102B may take a substantially round shape when a substantially round lens is positioned within the second lens portion 102B. As a further example, the interior perimeter 106 of the second lens portion 102B may take a substantially oval shape when a substantially oval lens is positioned within the second lens portion 102B.

In some embodiments, the exterior perimeter 105 of the at least one receiving portion is configured to take the shape of the lens that is positioned within the at least one lens portion. For example, the exterior perimeter 105 of the first lens portion 102A may take a substantially round shape when a substantially round lens is positioned within the first lens portion 102A. As another example, the exterior perimeter 105 of the first lens portion 102A may take a substantially oval shape when a substantially oval lens is positioned within the first lens portion 102A. As yet another example, the exterior perimeter 105 of the second lens portion 102B may take a substantially round shape when a substantially round lens is positioned within the second lens portion 102B. As a further example, the exterior perimeter 105 of the second lens portion 102B may take a substantially oval shape when a substantially oval lens is positioned within the second lens portion 102B. In some embodiments, the exterior perimeter 105 of the at least one receiving portion is configured to maintain its shape (e.g., original shape prior to positioning a lens therein). For example, in such some embodiments, the exterior perimeter 105 of the at least one lens portion (e.g., first lens portion 102A and second lens portion 102B) having a first shape may be configured to maintain the first shape after positioning a lens having a second shape that is different from the first shape with the at least one lens portion.

In various embodiments, a portion (e.g., some, all) of the at least one receiving portion (e.g., at least a portion of the first lens portion 102A and/or the second lens portion 102B) may be made from a flexible material. Alternatively or additionally, the at least one receiving portion may be made from elastic material. For example, the at least one receiving portion may be made from material that is flexible and/or elastic. By way of example, the at least one receiving portion may be made from rubber material. As another example, the at least one receiving portion may be made from plastic material. As yet another example, the at least one receiving portion may be made from graphene material. It should be understood that the at least one receiving portion may be made from a variety of flexible and/or elastic materials.

In some embodiments, the first arm 108A and/or the second arm 108B may be made from a biodegradable material. In some embodiments, the at least one receiving portion may be coated. In some embodiments, the at least one receiving portion may be painted in one or more colors. For example, the first lens portion 102A and/or the second lens portion 102B may be coated with any of a variety of materials and/or painted with any of a variety of materials.

The adaptable eyewear frame 100 may include at least one second frame member coupled to the first frame member. The at least one second frame member may be configured for removably securing the first frame member 102 to a user. The at least one second frame member may comprise a pair of arms. For example, as shown in the example embodiment depicted in FIG. 1, a first arm 108A and a second arm 108B may be coupled to the first frame member 102 for securing the first frame member 102 on a face of a user.

The first arm 108A and/or the second arm 108B may be made from any of a variety of materials. In some embodiments, the first arm 108A and/or the second arm 108B may be made from a flexible material. For example, the first arm 108A and/or the second arm 108B may be made from the same material as the first frame member 102. In some embodiments, the first arm 108A and/or the second arm 108B may be made from a rigid material. In some embodiments, the first arm 108A and/or the second arm 108B may be made from a plastic material. In some embodiments, the first arm 108A and/or the second arm 108B may be made from a metal material. In some embodiments, the first arm 108A and/or the second arm 108B may be made from a composite material. In some embodiments, the first arm 108A and/or the second arm 108B may be made from a biodegradable material. In some embodiments, the first arm 108A and/or the second arm 108B may be coated. In some embodiments, the first arm 108A and/or the second arm 108B may be painted in one or more colors.

In various embodiments, the first arm 108A and/or the second arm 108B may be fixedly secured to the first frame member 102. In various embodiments, the first arm 108A and/or the second arm 108B may be configured to be detachably secured to the first frame member 102. The first arm 108A and the second arm 108B may be configured to be secured to opposing end portions of the first frame member 102.

The first arm 108A and the second arm 108B may be secured to the first frame member 102 using one more of a variety of techniques. For example, one or more fastening members (e.g., hinges, screws, bolts, and/or the like) may be leveraged for securing the first arm 108A and the second arm 108B to the first frame member 102. In some embodiments, the first arm 108A and the second arm 108B are detachably secured to the first frame member 102. In some embodiments the first arm 108A and the second arm 108B may be integrally formed with respect to the first frame member 102. In such some embodiments, fastening members and/or the like may not be required.

In various embodiments, the first arm 108A may be configured to be pivotably secured to the first frame member 102 or otherwise secured to the first frame member 102 in such a manner that permits selective rotation of the first arm 108A and the first frame member 102. Additionally or alternatively, the second arm 108B may be configured to be pivotably secured to the first frame member 102 or otherwise secured to the first frame member 102 in such a manner that permits selective rotation of the second arm 108B and the first frame member 102. In various embodiments, the first arm 108A and/or the second arm 108B may be configured to be pivotally secured to the first frame member 102 utilizing hinges, screws, bolts, nuts, rods, the like, and or a combination thereof.

With reference to FIGS. 1-4, in various embodiments, the first arm 108A and the second arm 108B may include a first curved portion 114A and a second curved portion 114B, respectively. The first curved portion 114A and the second curved portion 114B may each be configured for being positioned on a user's ears to support the adaptable eyewear frame 100 on the face of the user when worn. In example embodiments where the first arm 108A and the second arm 108B are pivotally secured to the first frame member 102, the first arm 108A and the second arm 108B may be configured such that when the first arm 108A and the second arm 108B are folded towards an inner surface of the first frame member 102, each of the first arm 108A and the second arm 108B may be folded proximate to the inner surface of the first frame member 102. In various embodiments, the first arm 108A and the second arm 108B may be folded simultaneously.

### II. Exemplary Methods of Using the Adaptable Eyewear Frame

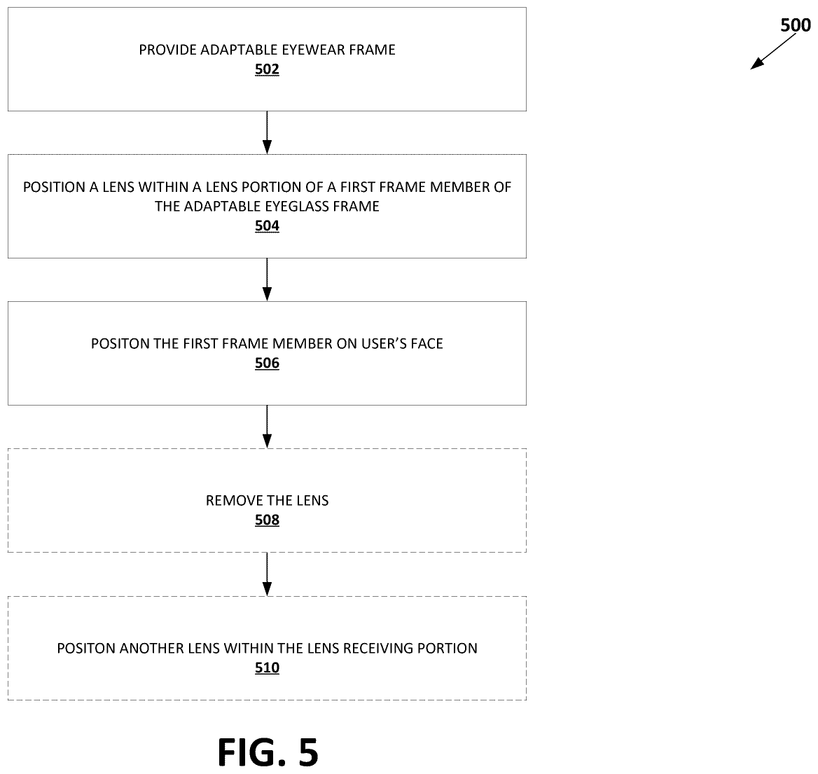

FIG. 5 provides a flowchart 500 illustrating a method of use of an adaptable eyewear frame in accordance with some embodiments described herein. Starting at block 502, an adaptable eyewear frame is provided. For example, an adaptable eyewear frame 100, as described above may be provided. As described above, the adaptable eyewear frame 100 may comprise a first frame member 102 defining at least one lens portion formed from flexible and/or elastic material. The at least one lens portion may define at least one opening configured to receive any lens of a plurality of lenses 130. At least one second frame member may be coupled to the first frame member for removably securing the first frame member to a user (e.g., user's face).

At block 504, at least one lens 130 is positioned within the at least one lens portion. For example, in embodiments where the adaptable eyewear frame 100 comprises a first lens portion 102A and a second lens portion 102B, a first lens 130 may be positioned within the first lens portion 102A and a second lens 130 may be positioned within the second lens portion 102B. In some embodiments, positioning the at least one lens with the at least one lens portion comprises positioning the at least one lens within a recess defined along an interior perimeter of the at least one lens portion. For example, the first lens may be positioned within a recess defined by a first rim portion 107A of the first lens portion 102A and the second lens may be positioned within a recess defined by a second rim portion 107B of the second lens portion 102B. In some embodiments where the adaptable eyewear frame comprises a single lens portion, a lens may be positioned within the single lens portion.

At block 506, the first frame member 102 is positioned on a user's face. The first frame member 102 may be positioned on a user's face such that an inner surface of the first frame member is positioned in a direction facing the user. For example, the first frame member 102 may be positioned on a user's face such that the first lens portion 102A and the second lens portion 102B are positioned in front of the user's right eye and left eye, respectively. In various embodiments, a portion of the first lens portion 102A and a portion of the second lens portion 102B may rest on the user's nose.

The first frame member 102 may be secured on the user's face using the at least one second frame member. As described above the adaptable eyewear frame 100 may comprise a first arm 108A and a second arm 108B configured for releasably securing the first frame member 102 on a user's face when the adaptable eyewear frame 100 is worn. The first curved portion 114A of the first arm 108A may be positioned on the user's right ear and the second curved portion 114B of the second arm 108B may be positioned on the user's left ear to further support the frame member positioned on the user's face.

In some embodiments, the adaptable eyewear frame 100 comprises a headband configured for securing the first frame member 102 on a user's face when the adaptable eyewear frame 100 is worn.

As described above, in some embodiments, the adaptable eyewear frame may function as a replacement eyewear frame. In such some embodiments, the method may optionally continue at block 508. At block 508, a lens positioned within the at least one receiving portion is removed. For example, in embodiments where the adaptable eyewear frame 100 comprises a first lens portion 102A and a second lens portion 102B, the first lens in the first lens portion 102A may be removed and/or the second lens in the second lens portion 102B may be removed.

At block 510, another lens is positioned within the at least one lens portion. For example, in embodiments where the adaptable eyewear frame 100 comprises a first lens portion 102A and a second lens portion 102B, the first lens in the first lens portion 102A may be removed and a third lens may be positioned within the first lens portion 102A and/or the second lens in the second lens portion 102B may be removed and a fourth lens may be positioned within the second lens portion 102B. In some examples, the lens removed from the at least one lens portion may have substantially the same shape as the other lens positioned within the at least one lens portion. In some examples, the lens removed from the at least one lens portion may have a shape that is different from the shape of the other lens positioned within the at least one lens portion. In some examples, the lens removed from the at least one lens portion may have substantially the same thickness as the other lens positioned within the at least one lens portion. In some examples, the lens removed from the at least one lens portion may have a thickness that is different from the thickness of the other lens positioned within the at least one lens portion.

### III. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An eyewear frame comprising:
a first frame member defining at least one lens portion formed from flexible material, the at least one lens portion defining at least one opening configured to receive any lens of a plurality of lenses; and
at least one second frame member coupled to the first frame member, the at least one second frame member configured for removably securing the first frame member to a user.

2. The eyewear frame of claim 1, wherein the at least one lens portion is configured to conform to any of the plurality of lenses positioned within the at least one lens portion to secure the lens within the first frame member.

3. The eyewear frame of claim 1, wherein the at least one lens portion takes a shape of a lens of the plurality of lenses that is positioned within the at least one lens portion.

4. The eyewear frame of claim 1, wherein the at least one lens portion defines a recess along an interior perimeter of the at least one lens portion for releasably securing a lens of the plurality of lenses within the at least one lens portion.

5. The eyewear frame of claim 1, wherein the at least one lens portion has an interior perimeter that is the same or less than a perimeter of each of the plurality of lenses prior to positioning a lens of the plurality of lenses therein.

6. The eyewear frame of claim 1, wherein the at least one lens portion is configured to expand when a lens of the plurality of lenses is placed within the at least one lens portion.

7. The eyewear frame of claim 1, wherein the at least one lens portion comprises a first lens portion and a second lens portion that are spaced apart relative to one another.

8. The eyewear frame of claim 1, wherein the at least one lens portion comprises a single lens portion that extends a width of the first frame member.

9. The eyewear frame of claim 1, wherein the plurality of lenses comprises a lens having a substantially round shape.

10. The eyewear frame of claim 1, wherein the plurality of lenses comprises a lens having an irregular shape.

11. The eyewear frame of claim 1, wherein the at least one second frame member comprises a first arm and a second arm.

12. The eyewear frame of claim 1, wherein the at least one second frame member comprises a headband.

13. An eyewear comprising:
an eyewear frame comprising:
a first frame member defining at least one lens portion formed from flexible material, the at least one lens portion defining at least one opening configured to receive any lens of a plurality of lenses; and
at least one second frame member coupled to the first frame member, the at least one second frame member configured for removably securing the first frame member to a user.

14. The eyewear of claim 13, further comprising at least one lens secured within the at least one lens portion.

15. A method for using an eyewear frame, the method comprising:
providing an adaptable eyewear frame comprising:
a first frame member defining at least one lens portion formed from flexible material, the at least one lens portion defining at least one opening configured to receive any lens of a plurality of lenses; and
at least one second frame member coupled to the first frame member,
the at least one second frame member configured for removably securing the first frame member to a user; and
positioning a lens of the plurality of lenses within the at least one lens portion.

16. The method of claim 15, further comprising:
positioning the first frame member on a user's face; and
securing the first frame member on the user's face using the at least one second frame member.

17. The method of claim 15, wherein the at least one lens portion defines a recess along an interior perimeter of the at least one lens portion, and positioning the lens within the at least one lens portion comprises positioning the lens within the recess.

18. The method of claim 15, wherein positioning the lens within the at least one lens portion comprises securing the lens within the at least one lens portion utilizing a friction-type fit.

19. The method of claim 15, wherein the at least one lens portion conforms to a shape of the lens.

20. The method of claim 15, further comprising:
removing the lens; and
positioning a different lens within the at least one lens portion.
